(19) United States
(12) Patent Application Publication
(10) Pub. No.: US 2024/0284573 A1
(43) Pub. Date: Aug. 22, 2024

(54) KEYBOARD DEVICE, COMPUTER SYSTEM, AND KEYBOARD CONTROL METHOD

(71) Applicant: TOPRE CORPORATION, Tokyo (JP)

(72) Inventor: Seiji HIRAKI, Sagamihara-shi (JP)

(73) Assignee: TOPRE CORPORATION, Tokyo (JP)

(21) Appl. No.: 18/581,766

(22) Filed: Feb. 20, 2024

(30) Foreign Application Priority Data
Feb. 22, 2023 (JP) 2023-026410

(51) Int. Cl. H05B 47/115; G06F 3/02; G06F 3/023; G06T 11/20; H05B 45/20

(52) U.S. Cl. CPC H05B 47/115; G06F 3/0202; G06F 3/023; G06T 11/206; H05B 45/20

(57) ABSTRACT

A keyboard device includes multiple keys, a pressing determination unit, a memory unit, an illumination unit that illuminates a keytop, and a keyboard control unit (110). The keyboard control unit (110) includes a pressing information acquisition unit (113) that acquires data on presence/absence of pressing of a key, and adds pressing count stored in the memory unit by one. The keyboard control unit (110) includes a maximum pressing count detection unit (114) that detects maximum pressing count based on pressing count of the multiple keys. In addition, the keyboard control unit (110) includes a pressing ratio determination unit (115) that determines a light emission color of the key, based on the pressing count of the multiple keys and the maximum pressing count. Further, the keyboard control unit (110) includes a light emission control instruction unit (116) that instructs the illumination unit to perform illumination corresponding to the light emission color.

### CROSS-REFERENCE TO RELATED APPLICATIONS

The present application is based on, and claims priority from Japanese Patent Application No. 2023-026410, filed on Feb. 22, 2023, the entire contents of which are incorporated herein by reference.

### TECHNICAL FIELD

The present disclosure relates to a keyboard device, a computer system, and a keyboard control method.

### BACKGROUND

Conventionally, software has been proposed for visualizing input frequency and the like of a computer keyboard and displaying the input frequency on a heat map. For example, in e-sports where a computer game (video game) is regarded as a sports competition, a heat map is used as a tool to learn about a player's habit and error input. U.S. Patent Application Publication No. 2016/0100465 discloses a computer device having a heat map function. According to the computer device disclosed in U.S. Patent Application Publication No. 2016/0100465, the computer receives key information inputted by a keyboard, and the computer analyzes the pressing frequency and pressing time of a key, and displays the result of the analysis on a color LED of the key.

### SUMMARY OF THE INVENTION

Generally, in e-sports, a high-performance computer is used together with a player's skill, because the faster reaction of the player determines a victory or a defeat of the game. In addition, the player considers to wish the processing ability of the computer to be occupied by the game software and not to wish other software to reside on the computer. However, in the computer device disclosed in U.S. Patent Application Publication No. 2016/0100465, the heat map software for processing the heat map described above is operated on the OS (operating system) of the computer. For this reason, the computer will run slower and the processing ability of the CPU will be consumed, and thus there is a possibility that the game software cannot be processed at high speed.

The present disclosure is to provide a control device for displaying a heat map visualizing input frequency and the like of a keyboard, and a keyboard device capable of reducing a load of a computer.

A keyboard device according to an embodiment includes a pressing determination unit that detects presence or absence of pressing of a key; a memory unit that stores pressing count of the key; an illumination unit that illuminates a keytop of the key; and a keyboard control unit, in which the keyboard control unit includes: a pressing information acquisition unit that acquires data on presence/absence of pressing of the key determined to be pressed by the pressing determination unit, and adds the pressing count stored in the memory unit by one; a maximum pressing count detection unit that detects a maximum value of the pressing count as maximum pressing count, based on the pressing count of the multiple keys stored in the memory unit; a pressing ratio determination unit that determines a light emission color of the key, based on the pressing count of the multiple keys and the maximum pressing count; and a light emission control instruction unit that instructs the illumination unit to perform illumination corresponding to the light emission color of the key.

A computer system according to the embodiment is a computer system including: a keyboard device described above; and a computer provided with a display unit, in which the computer receives information on the light emission color of the key from the keyboard device, and displays a heat map using the light emission color corresponding to the pressing count of the key of the keyboard device on the display unit.

A keyboard control method according to the embodiment is a keyboard control method executed by a computer, and the keyboard control method includes: acquiring data on presence/absence of pressing of a key determined to be pressed by a pressing determination unit that detects presence or absence of pressing of multiple keys pressed by a user; adding the pressing count of the key, which is determined to be pressed, stored in the memory unit by one; detecting a maximum value of the pressing count as maximum pressing count, based on the pressing count of the multiple keys stored in the memory unit; determining a light emission color of the key, based on the pressing count of the multiple keys and the maximum pressing count; and instructing an illumination unit, which illuminates a keytop of the key, to perform illumination corresponding to the light emission color of the key.

The above configuration makes it possible to provide a control device for displaying a heat map visualizing input frequency and the like of a keyboard, and a keyboard device capable of reducing a load of a computer.

### BRIEF DESCRIPTION OF DRAWINGS

FIG. 1 is a diagram illustrating a configuration of a computer system to which a keyboard device according to a present embodiment is applied.

FIG. 2 is a block diagram illustrating a functional configuration of the keyboard device according to the present embodiment.

FIG. 3 is a diagram for explaining pressing information according to the present embodiment.

FIG. 4 is a diagram for explaining a relationship between light emission colors displayed by the keyboard device according to the present embodiment and keyboard pressing count.

FIG. 5 is a diagram for explaining light emission of a keyboard by means of the keyboard device according to the present embodiment.

FIG. 6 is a flowchart illustrating an example of processing of the keyboard device according to the present embodiment.

FIG. 7 is a flowchart illustrating an example of processing of the keyboard device according to the present embodiment.

FIG. 8 is a diagram for explaining an example of displaying heat map information on a PC body in a computer system according to the present embodiment.

### DETAILED DESCRIPTION OF THE INVENTION

Hereinafter, a keyboard device 100 and a computer system 10 according to the present embodiment will be described with reference to the drawings.

### (Configuration of Computer System 10)

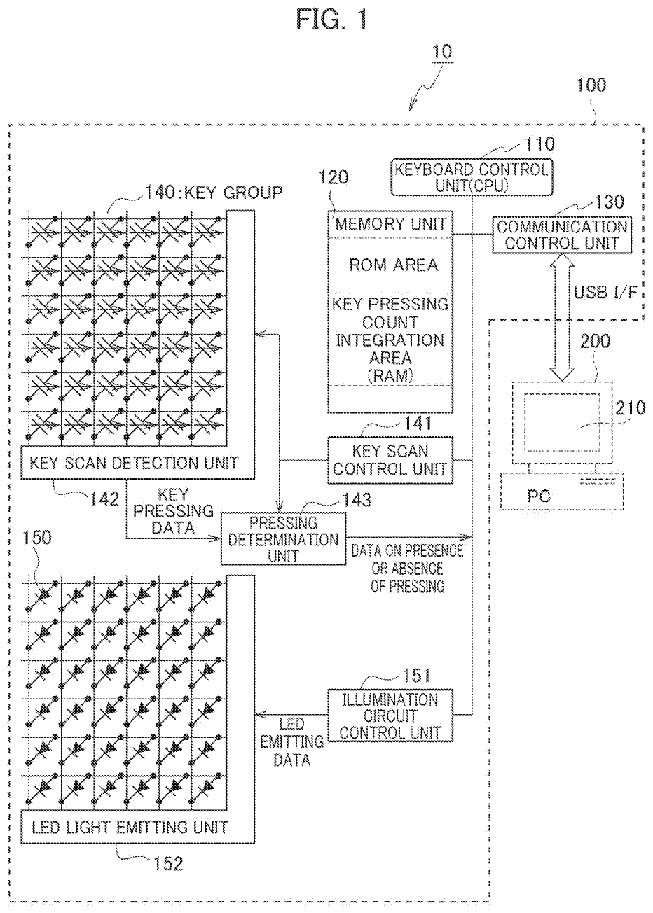

FIG. 1 is a diagram illustrating a configuration of the computer system 10 to which the keyboard device 100 according to the present embodiment is applied. The computer system 10 according to the present embodiment includes the keyboard device 100 and a personal computer 200 (PC) connected to the keyboard device 100.

### (Configuration of Personal Computer 200)

The personal computer 200 is a general-purpose computer, and an operating system (OS) operating on the personal computer 200 includes, for example, a multitasking function and a graphical user interface (GUI) function.

The personal computer 200 includes a display unit 210. Further, the personal computer 200 operates in response to a key code transmitted from the keyboard device 100 by pressing a key provided in the keyboard device 100.

### (Configuration of Keyboard Device 100)

The keyboard device 100 includes a keyboard control unit 110 (CPU), a memory unit 120, and a communication control unit 130. In addition, the keyboard device 100 includes a key group 140, a key scan control unit 141, a key scan detection unit 142, and a pressing determination unit 143. Further, the keyboard device 100 includes an illumination LED (light-emitting diode) 150, an illumination circuit control unit 151, and an LED light emitting unit 152.

In the present specification, the keyboard device 100 according to the present embodiment illustrates an example in which a capacitive switch is applied. Note that the type of the keyboard device 100 applied to the present embodiment is not limited to a capacitive switch, and a general keyboard such as a contact type key may be applied.

The keyboard control unit 110 controls the memory unit 120, the key scan control unit 141, the pressing determination unit 143, the illumination circuit control unit 151, and the communication control unit 130 which are provided in the keyboard device 100.

The keyboard control unit 110 is configured of a one-chip microcomputer, for example, and performs key switch control such as overall control of a keyboard system, a key scan, a key pressing determination, a key code conversion of a pressed key, and communication control. Further, the keyboard control unit 110 performs control such as integration processing of the number of key inputs and display, in the heat map according to the present embodiment. The details of the functions of the keyboard control unit 110 will be described later.

The memory unit 120 includes a read-only memory (ROM) and a random access memory (RAM). The read-only memory (ROM) may be a nonvolatile memory including a flash memory. In the ROM area, data and a control program related to the illumination color are stored in advance. The RAM area includes pressing information described later as a key pressing count integration area. The details of the pressing information will be described later.

The communication control unit 130 is an interface for communicating with the personal computer 200, and is configured of a well-known interface such as USB (registered trademark), for example.

The key group 140 includes (m rows×n columns) keys in an electrical circuit manner. Each key of the key group 140 is a key pressed by a user, and provided in a key switch unit. That is, the key switch unit includes a capacitive key switch and the illumination LED 150.

The key scan control unit 141 selects a relevant key address from the key group 140 in response to a control instruction from the keyboard control unit 110, and sequentially scans a key switch corresponding to the selected relevant key address. The key scan control unit 141 outputs the selected key address to the keyboard control unit 110.

The key scan detection unit 142 scans the key group 140, and outputs pressing data of the key that is selected by the key scan control unit 141.

The pressing determination unit 143 detects presence or absence of pressing of the key based on the pressing data of the key. In addition, the pressing decision unit 143 outputs data on the presence or absence of pressing of the key to the keyboard control unit 110 and the communication control unit 130.

The illumination LED 150 is mounted on a substrate (not illustrated), and three color LEDs of blue, red, and green which are integrated are arranged near the key switch to emit the characters on the keytops. In FIG. 1, the illumination LED 150 is included in the LED light emitting unit 152.

The illumination circuit control unit 151 emits the illumination LED 150 arranged at the lower part of the key switch unit. Specifically, the illumination circuit control unit 151 controls the illumination LED 150 in response to an illumination instruction from the keyboard control unit 110. In the present embodiment, the illumination unit corresponds to the illumination circuit control unit 151.

The LED light emitting unit 152 corresponds to LEDs arranged at the lower part of the key switch unit, and a control circuit thereof. The LED light emitting unit 152 emits the illumination LED 150 under the control of the illumination circuit control unit 151. Three color LEDs (R color, G color, B color) can be combined to emit the LEDs (illuminate the LEDs) in full color. The details of the LED light emitting unit 152 will be described later.

### (Functional Configuration of Keyboard Control Unit 110)

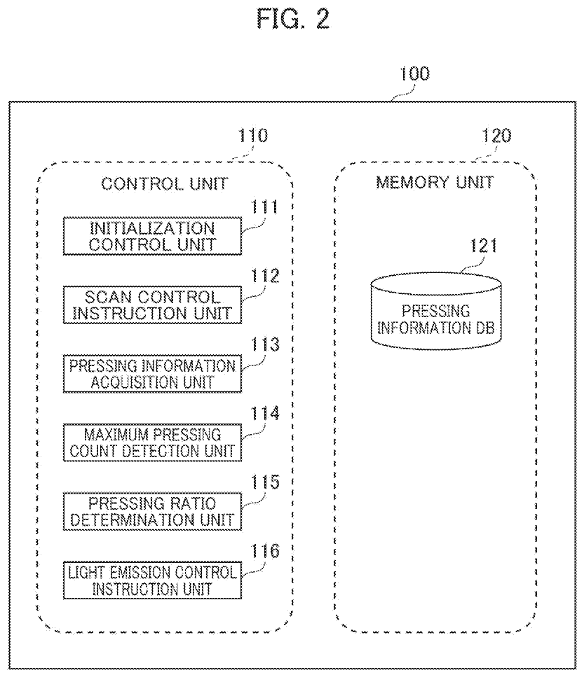

Next, a functional configuration of the keyboard control unit 110 according to the present embodiment will be described. FIG. 2 is a diagram illustrating the functional configuration of the keyboard control unit 110 according to the present embodiment, and pressing information DB 121 stored in the memory unit 120.

The keyboard control unit 110 includes an initialization control unit 111, a scan control instruction unit 112, a pressing information acquisition unit 113, a maximum pressing count detection unit 114, a pressing ratio determination unit 115, and a light emission control instruction unit 116 as a function.

The initialization control unit 111 initializes an integration value of pressing count of the key stored in the pressing information DB 121 of the memory unit 120. The initialization control unit 111 initializes the pressing count when the keyboard device 100 is activated. The initialization control unit 111 may also initialize the pressing count when a predetermined key is pressed via the keyboard device 100. The predetermined key may be pressed, for example, by using “Fn” (function key)+“Ctrl” (control key). In the present embodiment, the initialization (reset) of the pressing count performed by pressing the predetermined key is not limited to “Fn”+“Ctrl”, and a specific key may be assigned by the keyboard setting.

The scan control instruction unit 112 transmits a control instruction to the key scan control unit 141 to scan a plurality of key switches sequentially.

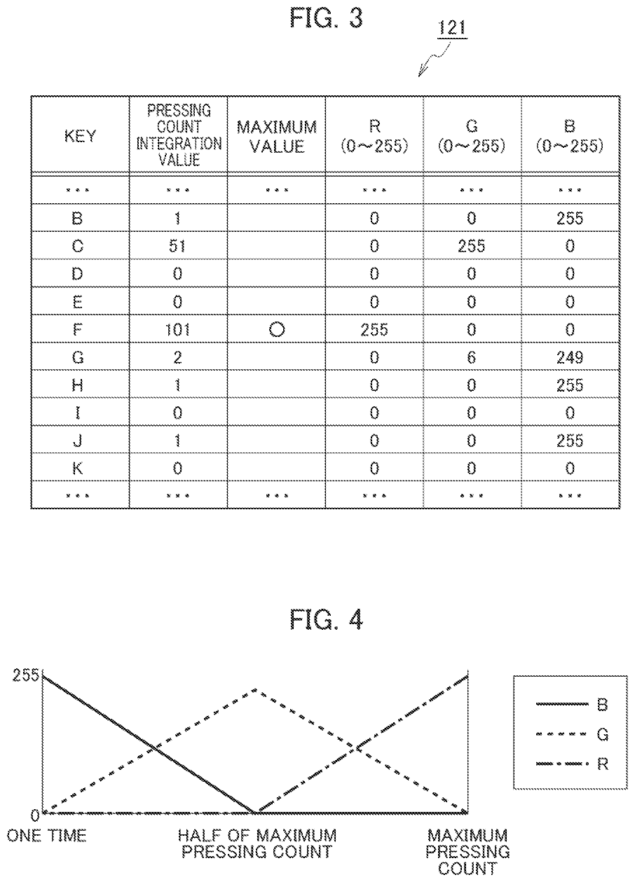

The pressing information acquisition unit 113 acquires data on the presence or absence of pressing of a key that is determined to be pressed by the pressing determination unit 143, and adds the pressing count of the pressing information DB 121 stored in the memory unit 120 by one. FIG. 3 is a diagram illustrating an example of the pressing information stored in the pressing information DB 121 according to the present embodiment. In the example illustrated in FIG. 3, the pressing information DB 121 stores information related to “key”, “pressing count integration value”, “maximum value”, “R”, “G”, and “B” as items.

The information related to “key” includes the information for identifying each key provided in the keyboard device 100. The “pressing count integration value” includes information related to an integration value of pressing count of the key that is pressed. The “maximum value” includes predetermined information for the key in which a maximum value is stored among the pressing count of each key. In the example illustrated in FIG. 3, since the “pressing count integration value” of the key whose information related to “key” is “F” is 100 as a maximum value, “O” is stored in the item of the “maximum value” whose information related to “key” is “F”.

The information stored in “R”, “G”, and “B” includes a value for determining the light emission color of the keyboard emitted by the illumination LED 150. In the example illustrated in FIG. 3, each of “R”, “G”, and “B” can be represented by 256 gradations of 0 to 255. That is, the light emission color of the illumination LED 150 in the present embodiment can represent 256×256×256=16777216 colors, based on gradations of three colors of red, green, and blue.

The maximum pressing count detection unit 114 detects a maximum value of pressing count as maximum pressing count, based on the pressing count of multiple keys stored in the memory unit 120. Specifically, the maximum pressing count detection unit 114 detects a key of which a pressing count integration value is maximum from the pressing count integration values of each key stored in the pressing information DB 121, and stores information indicating a maximum value in the field of “maximum value” of the pressing information.

As described above, in the example illustrated in FIG. 3, since the “pressing count integration value” of the key whose information related to “key” is “F” is 101 as a maximum value, “O” is stored in the item of the “maximum value” whose information related to “key” is “F”.

The pressing ratio determination unit 115 determines a light emission color of the key according to the pressing count of the key. Specifically, the pressing ratio determination unit 115 determines the light emission color of the key, based on the maximum pressing count, which is the maximum value of pressing count stored in the pressing information DB 121 of the memory unit 120, and the pressing count of the key. The pressing ratio determination unit 115 calculates a ratio obtained by dividing the pressing count of the key by the maximum pressing count among all the keys, and determines the light emission color according to the calculated ratio. Thus, the keyboard device 100 according to the present embodiment can assign a plurality of light emission colors according to the pressing count of the key, and the user can recognize the pressing count of the key more specifically, in comparison with the maximum pressing count.

FIG. 4 is a diagram for explaining light emission colors emitted by the illumination LED 150 according to the present embodiment. The pressing ratio determination unit 115 assigns a color as red (R) when the pressing count of the key matches the maximum pressing count. The pressing ratio determination unit 115 assigns a color as green (G) when the pressing count of the key is half of the maximum pressing count. Further, the pressing ratio determination unit 115 assigns a color as blue (B) when the pressing count of the key is one. In the present embodiment, the pressing ratio determination unit 115 assigns a color as green (G) when the maximum pressing count is one.

That is, in the example illustrated in FIG. 4, an emission color by using (R, G, B) in the case of the maximum pressing count is indicated by (255, 0, 0), and when the maximum pressing count is half (½), an emission color by using (R, G, B) is indicated by (0, 255, 0). Further, an emission color by using (R, G, B) when the maximum pressing count is one is indicated by (0, 0, 255). Furthermore, an emission color by using (R, G, B) when there is no pressing is indicated by (0, 0, 0).

More specifically, the value of red (R) is 0 up to half of the maximum pressing count, and the value thereof increases linearly from 0 to 255 from half of the maximum pressing count to the maximum pressing count. The value of green (G) increases linearly from 0 to 255 up to half of the maximum pressing count, and decreases linearly from 255 to 0 from half of the maximum pressing count to the maximum pressing count. Further, the value of blue (B) decreases linearly from 255 to 0 up to half of the maximum pressing count, and becomes 0 from half of the maximum pressing count to the maximum pressing count.

That is, in the present embodiment, the light emission color which changes according to the pressing count of the key is generated by combining gradations of three colors of red, green, and blue according to a ratio of the pressing count of the key with respect to the maximum pressing count. Thus, the user can visually recognize the pressing state of the key by checking the light emission color which changes sequentially according to the pressing count, thereby making it possible to continuously grasp the pressing count.

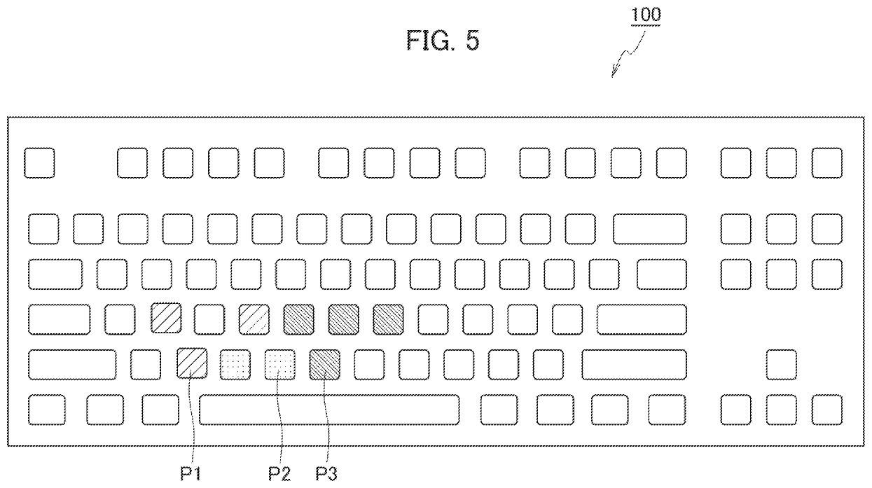

The light emission control instruction unit 116 instructs the illumination unit to perform illumination corresponding to the light emission color of the key. FIG. 5 schematically illustrates an example in which the light emission colors which are specified based on the pressing count integration values and maximum values illustrated in FIG. 3 are illuminated by the illumination LED 150 of the keyboard device 100.

FIG. 5 illustrates an example in which a pattern P1 corresponds to red, a pattern P2 corresponds to green, and a pattern P3 corresponds to blue. In the example illustrated in FIG. 5, the pressing count of the key “F” illustrated in FIG. 3 is maximum, and is illustrated by the pattern P1. Further, in the example illustrated in FIG. 3, the key “C” whose pressing count is half of the maximum pressing count is illustrated by the pattern P2. Furthermore, in the example illustrated in FIG. 3, the key “B” whose pressing count is one is illustrated by the pattern P3.

### (Outline of Processing Flow of Keyboard Control Unit 110)

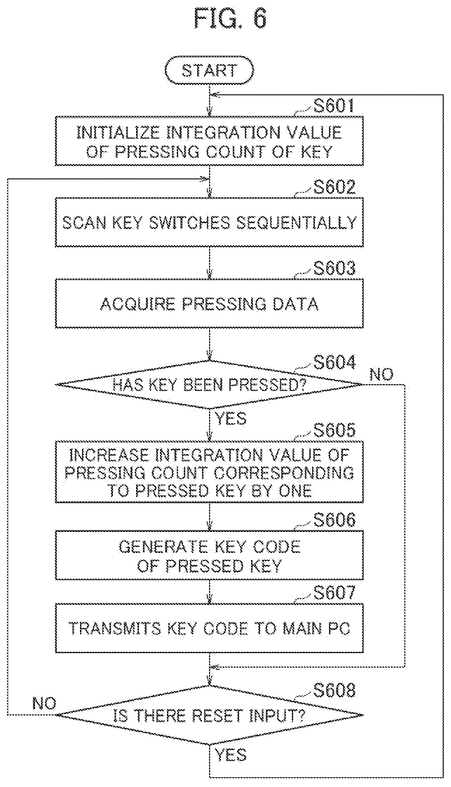

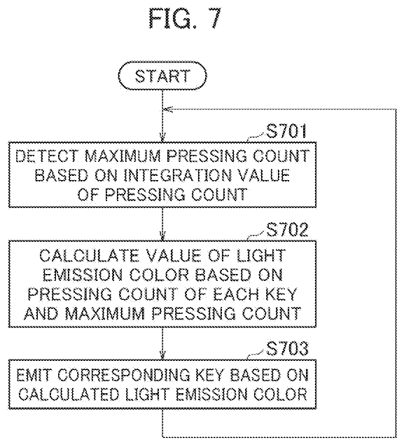

Next, a processing flow of the keyboard control unit 110 will be illustrated using the flowcharts illustrated in FIGS. 6 and 7. The sequence of operations of the keyboard control unit 110 illustrated in the flowcharts of FIGS. 6 and 7 may be started when the keyboard control unit 100 is activated by connecting the USB interface of the keyboard control unit 100 and the personal computer 200. Further, regarding the sequence of operations of the keyboard control unit 110 illustrated in the flowcharts of FIGS. 6 and 7, the processing ends when the USB interface is removed from the personal computer 200. In the flowcharts illustrated in FIGS. 6 and 7, the processing also ends when the power is switched OFF or the processing is interrupted. Furthermore, in the description of the flowcharts below, the same contents as those described in the description of the computer system 10 and the keyboard device 100 will be omitted or simplified.

First, the integration processing by pressing a key will be described in FIG. 6.
In step S601, the initialization control unit 111 initializes an integration value of pressing count of the key stored in the pressing information DB 121 of the memory unit 120. The initialization control unit 111 initializes the pressing count when the keyboard device 100 is activated. The initialization control unit 111 may also initialize the pressing count when a predetermined key is pressed via the keyboard device 100. Thereafter, the processing proceeds to step S602.
In step S602, the scan control instruction unit 112 transmits a control instruction to the key scan control unit 141 to scan a plurality of key switches sequentially. Thereafter, the processing proceeds to step S603.
In step S603, the pressing information acquisition unit 113 acquires pressing data indicating the presence/absence of pressing (data on presence/absence of pressing) from the pressing determination unit 143. Thereafter, the processing proceeds to step S604.
In step S604, the pressing information acquisition unit 113 determines whether a key has been pressed, based on the pressing data. In step S604, when the pressing information acquisition unit 113 determines that a key has been pressed (step S604: YES), the processing proceeds to step S605. On the other hand, when the pressing information acquisition unit 113 determines in step S604 that no key has been pressed (step S604: NO), the processing proceeds to step S608.
In step S605, the pressing information acquisition unit 113 acquires the data on the presence/absence of pressing of the key that is determined to be pressed by the pressing determination unit 143, and adds the pressing count of the pressing information DB 121 stored in the memory unit 120 by one. That is, the pressing information acquisition unit 113 increases an integration value of the pressing count corresponding to the pressed key by one. Thereafter, the processing proceeds to step S606.
In step S606, the keyboard control unit 110 generates a key code of the pressed key. Thereafter, the processing proceeds to step S607.
In step S607, the keyboard control unit 110 transmits the key code to the personal computer 200, which is the main PC, via the communication control unit 130. Thereafter, the processing proceeds to step S608.
In step S608, the initialization control unit 111 determines whether there is a reset input. In the present embodiment, a reset input is performed, for example, when a predetermined key is pressed through the keyboard device 100. The predetermined key may be pressed, for example, by using “Fn” (function key)+“Ctrl” (control key). In the present embodiment, the initialization (reset) of the pressing count performed by pressing the predetermined key is not limited to “Fn”+“Ctrl”, and a specific key may be assigned by the keyboard setting.
In step S608, when the initialization control unit 111 has determined that there is a reset input, the processing returns to step S601, and the processing from step S601 will be performed. On the other hand, when the initialization control unit 111 determines that there is no reset input in step S608, the processing returns to step S602, and the processing from step S602 will be performed.

Next, the illumination control will be described in FIG. 7.
In step S701, the maximum pressing count detection unit 114 detects a maximum value of pressing count as maximum pressing count, based on the pressing count of multiple keys stored in the memory unit 120. Specifically, the maximum pressing count detection unit 114 detects a key of which a pressing count integration value is maximum from the pressing count integration values of each key stored in the pressing information DB 121, and stores information indicating a maximum value in the field of “maximum value” of the pressing information. Thereafter, the processing proceeds to step S702.
In step S702, the pressing ratio determination unit 115 determines a light emission color of the key according to the pressing count of the key. Specifically, the pressing ratio determination unit 115 determines the light emission color of the key, based on the maximum pressing count, which is the maximum value of pressing count stored in the pressing information DB 121 of the memory unit 120, and the pressing count of the key. The pressing ratio determination unit 115 calculates a ratio obtained by dividing the pressing count of the key by the maximum pressing count among all the keys, and determines the light emission color according to the calculated ratio. Thereafter, the processing proceeds to step S703.
In step S703, the light emission control instruction unit 116 instructs the illumination unit to perform illumination corresponding to the light emission color of the key. Specifically, the light emission control instruction unit 116 emits the keytop of the corresponding key, based on the calculated light emission color. Thereafter, the processing returns to step S701, and the processing from step S701 will be repeatedly performed.

That is, in the present embodiment, the illumination control of the key illustrated in FIG. 7 is performed in parallel with the integration of the pressing count illustrated in FIG. 6.

As described above, the keyboard device 100 according to the present embodiment includes multiple keys pressed by a user, and the pressing determination unit 143 that detects presence or absence of pressing of a key. The keyboard device 100 also includes the memory unit 120 that stores pressing count of the key, an illumination unit that illuminates a keytop of the key, and the keyboard control unit 110. The keyboard control unit 110 includes the pressing information acquisition unit 113 that acquires data on presence/absence of pressing of the key determined to be pressed by the pressing determination unit 143, and adds the pressing count stored in the memory unit 120 by one. The keyboard device 100 also includes the maximum pressing count detection unit 114 that detects a maximum value of the pressing count as maximum pressing count, based on the pressing count of the multiple keys stored in the memory unit 120. The keyboard device 100 also includes the pressing ratio determination unit 115 that determines a light emission color of the key, based on the pressing count of the multiple keys and the maximum pressing count. Further, the keyboard device 100 includes the light emission control instruction unit 116 that instructs the illumination unit to perform illumination corresponding to the light emission color of the key. In the present embodiment, the illumination unit corresponds to the illumination circuit control unit 151.

This configuration makes it possible for the keyboard device 100 according to the present embodiment to display a heat map visualizing input frequency and the like of a keyboard on keytops of keys without imposing an extra load on the main body of the personal computer 200.

Further, the pressing ratio determination unit 115 determines the light emission color of the key according to a ratio of the pressing count of the key with respect to the maximum pressing count. This configuration makes it possible for the keyboard device 100 according to the present embodiment to assign a plurality of light emission colors according to the pressing count of the key, and the user can recognize the pressing count of the key more specifically, in comparison with the maximum pressing count.

Further, in the present embodiment, the light emission color of the key is generated by combining gradations of three colors of red, green, and blue according to a ratio of the pressing count of the key with respect to the maximum pressing count. Thus, the user who uses the keyboard device 100 can visually recognize the pressing state of the key by checking the light emission color which changes sequentially according to the pressing count, thereby making it possible to continuously grasp the pressing count.

### Other Embodiments

The above-described embodiment is merely an example for implementing the present embodiment. Therefore, the present embodiment is not limited to the above-described embodiment, and can be appropriately varied and implemented without departing from the spirit and scope of the embodiment.

In the present disclosure, although a description has been given regarding a keyboard having capacitive key switches, the keyboard need not be a capacitive keyboard. The keyboard device 100 may be any keyboard device as long as the keyboard device is an analog input device that includes switches for which thresholds can be set and from which the presence or absence of pressing (ON/OFF) can be output. For example, the keyboard device can be constituted of various types of switches such as a pressure-sensitive type switch, an electrical resistance type switch, a magnetism-sensitive type switch, an ultrasonic type switch, and an optical type switch. In addition, the keyboard can be constituted of a contact switch such as a membrane switch.

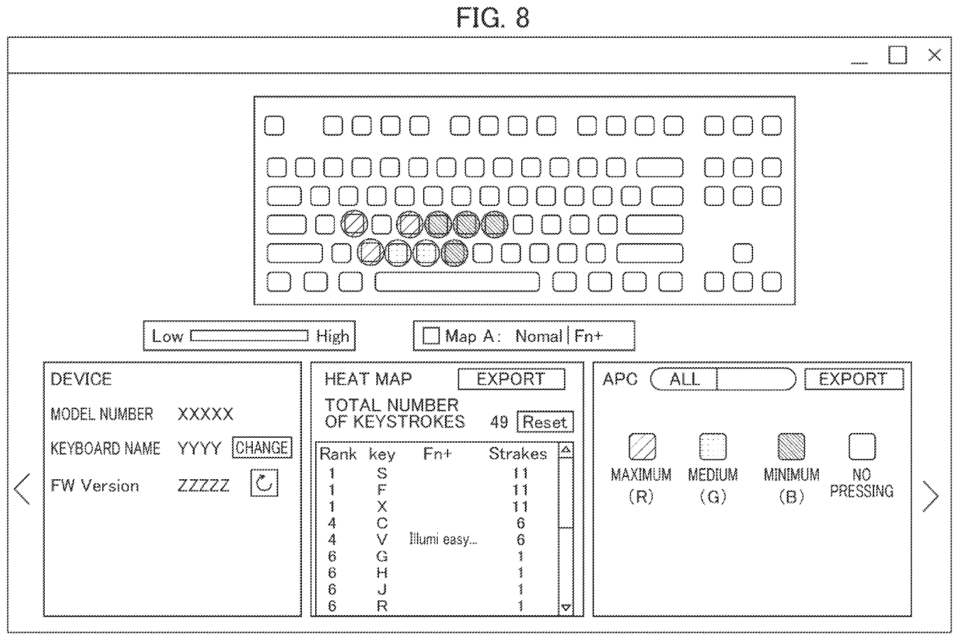

In the above embodiment, a description has been given regarding a configuration in which a keytop of a corresponding key is illuminated based on the light emission color calculated by the keyboard control unit 110. For example, a configuration may be employed in which a calculated light emission color is displayed on the screen of the personal computer 200. Specifically, such a configuration may be realized by the computer system 10 that includes the keyboard device 100 described above and the personal computer 200 provided with the display unit 210. The personal computer 200 receives information on the light emission color of the key from the keyboard device 100, and displays on the display unit 210, using the light emission color corresponding to the pressing count of the key of the keyboard device 100. FIG. 8 is a diagram illustrating an example of a heat map displayed on the display unit 210. As illustrated in FIG. 8, the heat map information indicated by the keyboard device 100 in FIG. 5 is displayed on the display unit 210. The light emission color is calculated by the keyboard device 100, and heat map information is displayed on the display unit 210 of the personal computer 200. This makes it possible to display the heat map information after the game ends, and look back the pressing locus of the player, thereby making it possible to learn about erroneous input. Further, “total number of keystrokes” and “49” are displayed slightly below the center in FIG. 8, which means that the pressing count integration values of the pressing information DB 121 illustrated in FIG. 3 are transmitted to the personal computer 200, and summed up and displayed on the display unit 210. This makes it possible to grasp the accumulated degree of use of the keyboard device, which can be used as a standard for grasping the degree of fatigue of e-sports players.

Further, a computer program (keyboard control program) which causes a computer to execute processing (keyboard control method) in the keyboard device 100, and a computer-readable recording medium on which the program is recorded are included in the scope of the present embodiment. Here, the type of computer-readable recording medium is optional. The computer program is not limited to the one recorded on the recording medium, and may be transmitted via a telecommunications line, a wireless or wired communication line, a network representing the Internet, or the like.

The operation and effect according to the present embodiment will be described below.
(1) The keyboard device 100 according to a first aspect includes multiple keys pressed by a user, and the pressing determination unit 143 that detects presence or absence of pressing of a key. The keyboard device 100 also includes the memory unit 120 that stores pressing count of the key, an illumination unit that illuminates a keytop of the key, and the keyboard control unit 110. The keyboard control unit 110 includes the pressing information acquisition unit 113 that acquires data on presence/absence of pressing of the key that is determined to be pressed by the pressing determination unit 143, and adds the pressing count stored in the memory unit 120 by one. The keyboard device 100 also includes the maximum pressing count detection unit 114 that detects a maximum value of the pressing count as maximum pressing count, based on the pressing count of the multiple keys stored in the memory unit 120. The keyboard device 100 also includes the pressing ratio determination unit 115 that determines a light emission color of the key, based on the pressing count of the multiple keys and the maximum pressing count. Further, the keyboard device 100 includes the light emission control instruction unit 116 that instructs the illumination unit to perform illumination corresponding to the light emission color of the key. In the present embodiment, the illumination unit corresponds to the illumination circuit control unit 151.

This makes it possible for the keyboard device 100 according to the present embodiment to display a heat map visualizing input frequency and the like of a keyboard on keytops of keys without imposing an extra load on the main body of the personal computer 200.
(2) The pressing ratio determination unit 115 of the keyboard device 100 according to a second aspect determines the light emission color of the key according to a ratio of the pressing count of the key with respect to the maximum pressing count.

This configuration makes it possible for the keyboard device 100 according to the present embodiment to assign a plurality of light emission colors according to the pressing count of the key, and the user can recognize the pressing count of the key more specifically, in comparison with the maximum pressing count.
(3) The light emission color of the key of the keyboard device 100 according to a third aspect is generated by combining gradations of three colors of red, green, and blue according to a ratio of the pressing count of the key with respect to the maximum pressing count.

Thus, the user who uses the keyboard device 100 can visually recognize the pressing state of the key by checking the light emission color which changes sequentially according to the pressing count, thereby making it possible to continuously grasp the pressing count.
(4) The computer system 10 according to a fourth aspect is the computer system 10 that includes the keyboard device 100 described above and a computer provided with the display unit 210. The computer receives information on the light emission color of the key from the keyboard device 100, and displays a heat map on the display unit 210, using the light emission color corresponding to the pressing count of the key of the keyboard device 100.

This makes it possible for the computer system 10 according to the present embodiment to display a heat map visualizing input frequency and the like of a keyboard on keytops of keys without imposing an extra load on the main body of the personal computer 200.
(5) The keyboard control method according to a fifth aspect is the keyboard control method executed by a computer. The keyboard control method includes acquiring data on presence/absence of pressing of a key determined to be pressed by the pressing determination unit 143 that detects presence or absence of pressing of multiple keys pressed by a user. The keyboard control method also includes adding the pressing count of the key, which is determined to be pressed, stored in the memory unit 120 by one. The keyboard control method also includes detecting a maximum value of the pressing count as maximum pressing count, based on the pressing count of the multiple keys stored in the memory unit 120. The keyboard control method also includes determining a light emission color of the key, based on the pressing count of the multiple keys and the maximum pressing count. Further, the keyboard control method includes instructing an illumination unit, which illuminates a keytop of the key, to perform illumination corresponding to the light emission color of the key.

This makes it possible for the keyboard control method according to the present embodiment to display a heat map visualizing input frequency and the like of a keyboard on keytops of keys without imposing an extra load on the main body of the personal computer 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A keyboard device including:
multiple keys pressed by a user;
a pressing determination unit that detects presence or absence of pressing of a key;
a memory unit that stores pressing count of the key;
an illumination unit that illuminates a keytop of the key; and
a keyboard control unit, and
wherein the keyboard control unit comprises:
a pressing information acquisition unit that acquires data on presence/absence of pressing of the key determined to be pressed by the pressing determination unit, and adds the pressing count stored in the memory unit by one;
a maximum pressing count detection unit that detects a maximum value of the pressing count as maximum pressing count, based on the pressing count of the multiple keys stored in the memory unit;
a pressing ratio determination unit that determines a light emission color of the key, based on the pressing count of the multiple keys and the maximum pressing count; and
a light emission control instruction unit that instructs the illumination unit to perform illumination corresponding to the light emission color of the key.

2. The keyboard device according to claim 1,
wherein the pressing ratio determination unit determines the light emission color of the key according to a ratio of the pressing count of the key with respect to the maximum pressing count.

3. The keyboard device according to claim 2,
wherein the light emission color of the key is generated by combining gradations of three colors of red, green, and blue according to a ratio of the pressing count of the key with respect to the maximum pressing count.

4. A computer system including:
a keyboard device according to claim 1; and
a computer provided with a display unit, and
wherein the computer receives information on the light emission color of the key from the keyboard device, and displays a heat map using the light emission color corresponding to the pressing count of the key of the keyboard device on the display unit.

5. A keyboard control method executed by a computer, the keyboard control method comprising:
acquiring data on presence/absence of pressing of a key determined to be pressed by a pressing determination unit that detects presence or absence of pressing of multiple keys pressed by a user;
adding the pressing count of the key, which is determined to be pressed, stored in the memory unit by one;
detecting a maximum value of the pressing count as maximum pressing count, based on the pressing count of the multiple keys stored in the memory unit;
determining a light emission color of the key, based on the pressing count of the multiple keys and the maximum pressing count; and
instructing an illumination unit, which illuminates a keytop of the key, to perform illumination corresponding to the light emission color of the key.
